(19) United States
(12) Patent Application Publication
(10) Pub. No.: US 2025/0066689 A1
(43) Pub. Date: Feb. 27, 2025

(54) PROCESS FOR REMOVING IMPURITIES FROM VEGETABLE OIL

(71) Applicant: CARGILL, INCORPORATED, Wayzata, MN (US)

(72) Inventor: Falk BRUSE, Drensteinfurt (DE)

(21) Appl. No.: 18/719,312

(22) PCT Filed: Dec. 20, 2022
(86) PCT No.: PCT/US2022/082026

§ 371 Date: Jun. 13, 2024

(30) Foreign Application Priority Data
Dec. 21, 2021 (EP) 21216693.8

(51) Int. Cl. C11B 3/12; B01D 1/00; B01D 1/08; B01D 3/14; B01D 3/34

(52) U.S. Cl. CPC C11B 3/12; B01D 1/0082; B01D 1/08; B01D 3/148; B01D 3/346

(57) ABSTRACT

The present invention relates to a process for removing impurities from vegetable oil, wherein the process is comprising the step of subjecting a vegetable oil to a short-path evaporation, wherein the short-path evaporation is performed at a pressure of below 1 mbar, at an evaporator temperature in a range of from 50 to below 150° C. and with a feed rate per unit area of evaporator surface of the short-path evaporation equipment of more than 25 kg/h·m², and thus obtaining a retentate vegetable oil and a distillate. The present invention further relates to the use of a short-path evaporation for removing impurities from a vegetable oil.

### CROSS-REFERENCE TO RELATED APPLICATION

This application claims the benefit of European Patent Application No. 21216693.8, filed Dec. 21, 2021, which is incorporated by reference in its entirety.

### FIELD OF THE INVENTION

The present invention relates to a novel process comprising short-path evaporation for removing impurities from vegetable oil.

### BACKGROUND OF THE INVENTION

Crude oils, as extracted from their original source, are not suitable for human consumption due the presence of impurities—such as free fatty acids, phosphatides, metals and pigments—which may be harmful or may cause an undesirable colour, odour or taste. Crude oils are therefore often refined before use. The refining process typically comprises at least one process step that is performed at high temperatures over a longer period of time, such as a deodorization step. The oil obtained after completion of the refining process (called a “refined oil” or more specifically a deodorized oil) has a bland odor and taste and is suitable for human consumption. Optionally, when the quality of refined oils has degraded due to bad storage or transportation, oils may be subjected to a subsequent process step that is performed at high temperatures over a longer period of time for restoring their quality.

Unfortunately, refining process steps that are performed at high temperatures are not environmentally friendly due to their high energy consumption. Additionally, these high temperature conditions may also damage the composition of certain fats and/or destroy beneficial minor components in the oils that are contributing to the nutritional value of these oils.

There is a need in the industry to identify a mild and environmentally friendly process for efficiently and effectively removing impurities from vegetable oils. The present invention provides such a process.

### SUMMARY OF THE INVENTION

The present invention relates to a process for removing impurities from vegetable oil, wherein the process is comprising the step of subjecting a vegetable oil to a short-path evaporation, wherein the short-path evaporation is performed at a pressure of below 1 mbar, at an evaporator temperature in a range of from 50 to below 150° C. and with a feed rate per unit area of evaporator surface of the short-path evaporation equipment of more than 25 kg/h·m², and thus obtaining a retentate vegetable oil and a distillate.

The present invention further relates to the use of short-path evaporation for removing impurities from a vegetable oil, wherein the short-path evaporation is performed at a pressure of below 1 mbar, at an evaporator temperature in a range of from 50 to below 150° C. and with a feed rate per unit area of evaporator surface of the short-path evaporation equipment of more than 25 kg/h·m², and wherein a retentate vegetable oil and a distillate is obtained.

### DETAILED DESCRIPTION

The present invention relates to a process for removing impurities from vegetable oil, wherein the process is comprising the step of subjecting a vegetable oil to a short-path evaporation on a short-path evaporation equipment having an evaporator surface, wherein the short-path evaporation is performed at a pressure of below 1 mbar, at an evaporator temperature in a range of from 50 to below 150° C. and with a feed rate per unit area of evaporator surface of the short-path evaporation equipment of more than 25 kg/h·m², and thus obtaining a retentate vegetable oil and a distillate.

### Vegetable Oil as Starting Material

The vegetable oil that is subjected to the short-path evaporation of the process of the invention may be derived from one or more vegetable sources and may include oils and/or fats from a single origin or blends of two or more oils and/or fats from different sources or with different characteristics.

Examples of suitable vegetable oils include algal oil, camelina oil, coconut oil, corn oil, cottonseed oil, cottonseed oil fractions, grape seed oil, hazelnut oil, high-oleic sunflower oil, jojoba oil, kapok seed oil, linseed oil, olive oil, palm oil, palm oil components, palm kernel oil, palm kernel stearin, palm kernel olein, peanut oil, pecan oil, perilla oil, pistachio oil, poppy seed oil, rapeseed oil, rice bran oil, safflower oil, sesame oil, sunflower oil, high- and mid-oleic sunflower oil, soybean oil, walnut oil, wheat germ oil, babassu oil, cohune oil, tacum oil, cuphea oil or any combination of two or more thereof. Preferably, the vegetable oil that is subjected to the short-path evaporation of the process of the invention is selected from the list consisting of algal oil, camelina oil, coconut oil, corn oil, cottonseed oil, cottonseed oil fractions, linseed oil, palm oil, palm oil components, palm kernel oil, palm kernel stearin, palm kernel olein, peanut oil, rapeseed oil, rice bran oil, safflower oil, sesame oil, sunflower oil, high- and mid-oleic sunflower oil, soybean oil, and any combination of two or more thereof.

More preferably, the vegetable oil that is subjected to the short-path evaporation of the process of the invention is selected from the list consisting of camelina oil, coconut oil, corn oil, cottonseed oil, cottonseed oil fractions, linseed oil, palm oil, palm oil components, palm kernel oil, palm kernel stearin, palm kernel olein, rapeseed oil, sunflower oil, high- and mid-oleic sunflower oil, soybean oil, and any combination of two or more thereof.

Most preferably, the vegetable oil that is subjected to the short-path evaporation of the process of the invention is selected from the list consisting of coconut oil, corn oil, cottonseed oil, cottonseed oil fractions, palm oil, palm stearin, palm olein, palm mid fractions, palm kernel oil, palm kernel stearin, palm kernel olein, rapeseed oil, sunflower oil, high- and mid-oleic sunflower oil, soybean oil, and any combination of two or more thereof.

Palm oil components are encompassing stearin and olein fractions (single as well as double fractionated, and palm mid fractions), hydrogenated palm oil or hydrogenated palm oil fractions, interesterified palm oil or interesterified palm oil fractions, blends of 2 or more thereof, and blends thereof with palm oil.

The vegetable oil that is subjected to the short-path evaporation of the process of the invention may be derived from one or more vegetable sources and may include oils and/or fats from a single origin, or blends of two or more oils and/or fats from different sources or with different characteristics. The vegetable oil may be a crude oil or may have been subjected to a refining process, such as, but not limited to, neutralization, degumming, bleaching, and/or deodorization. The vegetable oil may be also be derived from oils and/or fats that have been subjected to a process for modifying the structure of the oils and/or fats, such as, but not limited to, fractionation, hydrogenation, interesterification or a combination of two or more processes thereof.

In one aspect of the invention, the vegetable oil that is subjected to the short-path evaporation of the process is a degummed, bleached and/or deodorized vegetable oil. Preferably the vegetable oil is at least degummed. More preferably, the vegetable oil is at least neutralized and degummed.

Crude vegetable oil may be subjected to one or more degumming steps. Any of a variety of degumming processes known in the art may be used. One such process (known as “water degumming”) includes mixing water with the oil and separating the resulting mixture into an oil component and an oil-insoluble hydrated phosphatides component, sometimes referred to as “wet gum” or “wet lecithin”. Alternatively, phosphatide content can be reduced (or further reduced) by other degumming processes, such as acid degumming (using citric or phosphoric acid for instance), enzymatic degumming (e.g., ENZYMAX from Lurgi) or chemical degumming (e.g., SUPERIUNI degumming from Unilever or TOP degumming from VandeMoortele/Dijkstra CS). Alternatively, phosphatide content can also be reduced (or further reduced) by means of acid conditioning, wherein the oil is treated with acid in a high shear mixer and is subsequently sent without any separation of the phosphatides to the bleaching step.

The bleaching step in general is a process step whereby impurities are removed to improve the color and flavor of the oil. It is typically performed prior to deodorization. The nature of the bleaching step will depend, at least in part, on the nature and quality of the oil being bleached. Generally, a crude or partially refined oil will be mixed with a bleaching agent which combines, amongst others, with oxidation products, phosphatides, trace soaps, pigments and other compounds to enable their removal. The nature of the bleaching agent can be selected to match the nature of the crude or partially refined oil to yield a desirable bleached oil. Bleaching agents generally include natural or “activated” bleaching clays, also referred to as “bleaching earths”, activated carbon and various silicates. Natural bleaching agent refers to non-activated bleaching agents. They occur in nature or they occur in nature and have been cleaned, dried, milled and/or packed ready for use. Activated bleaching agent refers to bleaching agents that have been chemically modified, for example by activation with acid or alkali, and/or bleaching agents that have been physically activated, for example by thermal treatment. Activation includes the increase of the surface in order to improve the bleaching efficiency.

Further, bleaching clays may be characterized based on their pH value. Typically, acid-activated clays have a pH value of 2.0 to 5.0. Neutral clays have a pH value of 5.5 to 9.0. A skilled person will be able to select a suitable bleaching agent from those that are commercially available based on the oil being refined and the desired end use of that oil.

The bleaching step for obtaining the degummed and bleached vegetable oil that is subjected to the short-path evaporation of the process, is performed at a temperature of from 80 to 115° C., from 85 to 110° C., or from 90 to 105° C., in presence of bleaching earth in an amount of from 0.2 to 5%, from 0.5 to 3%, or from 0.7 to 1.5% based on amount of oil.

Deodorization is a process whereby free fatty acids (FFAs) and other volatile impurities are removed by treating (or “stripping”) a crude or partially refined oil under vacuum and at elevated temperature with sparge steam, nitrogen or other gasses. The deodorization process and its many variations and manipulations are well known in the art and the deodorization step of the present invention may be based on a single variation or on multiple variations thereof.

For instance, deodorizers may be selected from any of a wide variety of commercially available systems (such as those sold by Krupp of Hamburg, Germany; De Smet Group, S.A. of Brussels, Belgium; Gianazza Technology s.r.l. of Legnano, Italy; Alfa Laval AB of Lund, Sweden Crown Ironworks of the United States, or others). The deodorizer may have several configurations, such as horizontal vessels or vertical tray-type deodorizers.

Deodorization is typically carried out at elevated temperatures and reduced pressure to better volatilize the FFAs and other impurities. The precise temperature and pressure may vary depending on the nature and quality of the oil being processed. The pressure, for instance, will preferably be no greater than 10 mm Hg but certain aspects of the invention may benefit from a pressure below or equal to 5 mm Hg, e.g. 1-4 mm Hg. The temperature in the deodorizer may be varied as desired to optimize the yield and quality of the deodorized oil. At higher temperatures, reactions which may degrade the quality of the oil will proceed more quickly. For example, at higher temperatures, cis-fatty acids may be converted into their less desirable trans form. Operating the deodorizer at lower temperatures may minimize the cis-to-trans conversion, but will generally take longer or require more stripping medium or lower pressure to remove the requisite percentage of volatile impurities. As such, deodorization is typically performed at a temperature of the oil in a range of from above 180 to 280° C., with temperatures of about 220-270° C. being useful for many oils. Typically, deodorization is thus occurring in a deodorizer whereby volatile components such as FFAs and other unwanted volatile components that may cause off-flavors in the oil, are removed. Deodorization may also result in the thermal degradation of unwanted components.

The deodorization step for obtaining the degummed, bleached and deodorized vegetable oil that is subjected to the short-path evaporation of the process, is performed at a temperature of from above 180° C. to 270° C., from 210° C. to 260° C., or from 220° C. to 250° C. The deodorization step is taking place for a period of time from 30 min to 240 min, from 45 min to 180 min, or from 60 min to 150 min.

The deodorization step for obtaining the degummed, bleached and deodorized vegetable oil that is subjected to the short-path evaporation of the process, is performed in the presence of sparge steam in a range of from 0.50 to 2.50 wt %, from 0.75 to 2.00 wt %, from 1.00 to 1.75 wt %, or from 1.25 to 1.50 wt % based on amount of oil, and at an absolute pressure of 10 mbar or less, 7 mbar or less, 5 mbar or less, 3 mbar or less, 2 mbar or less.

Typically, a degummed, bleached and deodorized vegetable edible oil is known to be obtained by means of 2 major types of refining processes, i.e. a chemical or a physical refining process. The chemical refining process may typically comprise the major steps of degumming, alkali refining, also called neutralization, bleaching and deodorizing. The thus obtained deodorized oil is a chemically refined oil, also called “NBD” oil. Alternatively, the physical refining process may typically comprise the major steps of degumming, bleaching and deodorizing. A physically refining process is not comprising an alkali neutralization step as is present in the chemical refining process. The thus obtained deodorized oil is a physically refined oil, also called “RBD” oil.

In one aspect of the invention, the vegetable oil that is that is subjected to the short-path evaporation of the present process is a vegetable oil that has been subjected to a treatment at a temperature above 180° C. prior to this short-path evaporation step and the vegetable oil has an FFA content in a range of more than 0.05%, 0.08% or more than 0.1% and/or a peroxide value of more than 0.5 meq peroxide/kg, more than 0.8 meq peroxide/kg, or more than 1.0 meq peroxide/kg. A treatment at a temperature above 180° C., may be, but is not limited to, a deodorization. Vegetable oils that have been subjected to a treatment at a temperature above 180° C. are typically RBD or NBD oils. The vegetable oil that has been subjected to a treatment at a temperature above 180° C. prior to the short-path evaporation step may be an RBD or NBD oil selected from the group consisting of palm oil, palm oil components, rapeseed oil, sunflower oil, high- and mid-oleic sunflower oil, coconut oil, palm kernel oil, palm kernel stearin, palm kernel olein, soybean oil, corn oil, cottonseed oil, cottonseed oil fractions and any combination of two or more thereof. These RBD or NBD oils may have an elevated level of FFA and/or peroxide value due to bad refining conditions or due to aging of the oil as a result of long and/or bad conditions of storage and/or transportation. Apart from an elevated level of FFA and/or peroxide value, these oils typically also have an off taste, such as but not limited to rancid taste or cardboard taste, and/or a darker color.

FFA is measured according to official AOCS method Ca 5a-40. The percentage of FFA (expressed as weight percentage on total weight of oil) is calculated as oleic acid, except for lauric oils such as coconut oil and palm kernel oil, wherein the FFA % is expressed as lauric acid, and for palm oil and palm oil components, wherein the % FFA is expressed as palmitic acid.

Peroxide value, in meq peroxide/kg, is measured according to official AOCS method Cd 8b-90. It is a method well-known in the art for measuring peroxides or similar products of fat oxidation that may be present in the oil.

In an alternative aspect of the invention, the vegetable oil that is subjected to the short-path evaporation of the process is a vegetable oil that has not been subjected to a treatment at a temperature above 180° C. prior to the short-path evaporation step. The vegetable oil that has not been subjected to a treatment at a temperature above 180° C. prior to the short-path evaporation step may be selected from the group consisting of algal oil, camelina oil, corn oil, cottonseed oil, grape seed oil, hazelnut oil, jojoba oil, kapok seed oil, linseed oil, olive oil, peanut oil, pecan oil, perilla oil, pistachio oil, poppy seed oil, rapeseed oil, red palm oil, red palm oil olein (mono and double fractionated olein), rice bran oil, safflower oil, sesame oil, sunflower oil, high- and mid-oleic sunflower oil, soybean oil, walnut oil, wheat germ oil, and any combination of two or more thereof.

Preferably the vegetable oil that has not been subjected to a treatment at a temperature above 180° C. has an iodine value (IV) of more than 70, more than 90 or more than 130. The IV is a measure of the level of unsaturation of the oil. The vegetable oil that has not been subjected to a treatment at a temperature above 180° C. prior to the short-path evaporation step and is having an IV of more than 70 may be selected from the group consisting of algal oil, camelina oil, corn oil, cottonseed oil, grape seed oil, hazelnut oil, oil, jojoba oil, kapok seed oil, linseed oil, olive oil, peanut oil, pecan oil, perilla oil, pistachio oil, poppy seed oil, rapeseed oil, rice bran oil, safflower oil, sesame oil, sunflower oil, high- and mid-oleic sunflower soybean oil, walnut oil, wheat germ oil, and any combination of two or more thereof.

Iodine value can be calculated directly from the fatty acid composition according to AOCS method Cd1c-85.

### Short-Path Evaporation

Short-path evaporation, also called short-path distillation or molecular distillation, is a distillation technique that involves the distillate travelling a short distance, often only a few centimetres, and it is normally done at reduced pressure. With short path distillation, a decrease of boiling temperature is obtained by reducing the operating pressure. It is a continuous process with very short residence time. This technique is often used for compounds which are unstable at high temperatures or to purify small amounts of compounds. The advantage is that the heating temperature can be considerably lower (at reduced pressure) than the boiling point of the liquid at standard pressure. Additionally, short-path evaporation allows working at very low pressure.

Different types of short-path evaporation apparatus can be used that are well known to the skilled person. Examples are, but are not limited to, falling film, centrifugal, or wiped film evaporation apparatus. Preferably the short-path evaporation of the current process is performed in a wiped film evaporation apparatus.

The short-path evaporation is performed at a pressure below 1 mbar, preferably below 0.05 mbar, more preferably below 0.01 mbar, most preferably below 0.001 mbar.

The short-path evaporation is further performed at specific conditions of temperature and feed rate per unit area of evaporator surface of the short-path evaporation equipment.

The “feed rate per unit area of evaporator surface of the short-path evaporation equipment”, also called “specific throughput” or “specific feed rate”, expressed in kg/h·m², is defined as the flow of oil, expressed in kg/h, per unit area of evaporator surface of the short-path evaporation equipment, expressed in square meters (m²). The feed rate per unit area of evaporator surface of the short-path evaporation equipment in the process of the current invention is applicable to any short path equipment, including industrial short-path evaporation equipment independent of the dimensions of the equipment. Preferably stainless steel short-path evaporation equipment is used in the current invention.

The short-path evaporation of the current process is performed at an evaporator temperature in a range of from 50 to below 150° C., from 55 to 140° C., or from 60 to 130° C., or from 70° C. to 120° C., and with a feed rate per unit area of evaporator surface of the short-path evaporation equipment of more than 25 kg/h·m², more than 35 kg/h·m², or more than 45 kg/h·m², and up to 120 kg/h·m², up to 110 kg/h·m², up to 80 kg/h·m², such as in a range of from 27 kg/h·m² to 75 kg/h·m².

The step of subjecting a vegetable oil to a short-path evaporation may be carried out multiple times, up to 5 times, up to 3 times, or 2 times. Repetition of the short-path evaporation step may occur by recirculating the treated oil over the same short-path evaporation equipment, or by serial set-ups of these equipments, or by a combination of the two.

In the process according to the invention, two fractions are obtained from the short-path evaporation: a retentate vegetable oil and a distillate.

The process according to the invention results in a retentate vegetable oil having a reduced content of impurities and a distillate having an elevated content of impurities, compared to the vegetable oil that is subjected to the short-path evaporation. Examples of impurities are compounds such as, but not limited to, aldehydes, ketones, peroxides, solvents, alkanes having a carbon chain length up to C10, MOSH (Mineral Oil Saturated Hydrocarbons) having a carbon chain length between C10 and C35, MOAH (Mineral Oil Aromatic Hydrocarbons) having a carbon chain length between C10 and C35, FFA, GE (Glycidyl Esters).

Surprisingly, it has been found that the process according to the invention, performing a short-path evaporation step at low temperatures results in a retentate vegetable oil having a reduction of impurities, a reduced peroxide value, a better taste and/or a better maintenance of its original color. Such short-path evaporation processes conducted at low temperatures are less energy consuming than commonly used refining processes that are operated at much higher temperatures. Additionally, such low temperatures also cause less thermal stress to vegetable oils, especially important for highly unsaturated vegetable oils.

The process according to the invention results in a yield of the retentate vegetable oil that is more than 95%, or more than 99%, or more than 99.8%. The yield is expressed as the ratio of the amount of retentate vegetable liquid oil that is obtained versus the amount of vegetable liquid oil that was subjected to the short-path evaporation.

The process according to the invention, which is performing a short-path evaporation step at low temperatures may result in a retentate vegetable oil having a reduction of the peroxide value by at least 30%, at least 40%, at least 50%. Furthermore, the process according to the invention may result in a retentate vegetable oil having a reduction of MOSH and/or MOAH having a carbon chain length in a range of 10 to 35 by at least 20%, at least 30%, at least 40%.

The process according to the invention may result in a retentate vegetable oil having an overall flavour quality score (taste), according to AOCS method Cg 2-83, in a range of from 7 to 10, or from 8 to 10 or from 9 to 10 (with 10 being an excellent overall flavour quality score and 1 being the worst score).

In case of vegetable oil that has been subjected to a treatment at a temperature above 180° C. prior to the short-path evaporation step, the process according to the invention may result in a retentate vegetable oil that is less dark than a vegetable oil obtained by means of commonly used refining processes that are operated at much higher temperatures.

In case of vegetable oil that has not been subjected to a treatment at a temperature above 180° C. prior to the short-path evaporation step, the process according to the invention may result in an improved stability of the desired colour of the retentate vegetable oil compared to the colour of a vegetable oil obtained by means of commonly used refining processes that are operated at much higher temperatures.

In a specific aspect of the invention, the process is for removing impurities from a vegetable oil that has not been subjected to a treatment at a temperature above 180° C. prior to the short-path evaporation step, is further comprising the step subjecting the obtained retentate vegetable oil to a further refining carried out in an oil refining equipment consisting of a stripping column with packing and not more than one oil collection tray, or in a deodorizer at a temperature below 150° C., below 140° C., or below 130° C., and a refined retentate vegetable oil is obtained.

The further refining step may be carried out in the presence of sparge steam in an amount of from 0.1 to 2.0 wt %, from 0.2 to 1.8 wt %, or from 0.3 to 1.5 wt %, based on amount of oil.

The further refining step may be carried out at an absolute pressure of 10 mbar or less, 7 mbar or less, or 5 mbar or less.

In a more specific aspect, the further refining step may be carried out in an oil refining equipment consisting of a stripping column with packing and not more than one oil collection tray. The refining ability of this refining equipment is obtained from the use of the stripping column and not more than one oil collection tray. It is to be understood that in order to operate the refining equipment, valves, pumps, heat exchangers (heating and/or cooling of the oil), and the like, are needed. An in-line heater may be used before the stripping column.

The “not more than one” oil collection tray is a range covering “up to one” collection tray, and thus including also no collection tray.

The “oil refining equipment” is not containing retention trays. Retention trays, retention vessels, or compartments, also known as sections, are always present in standard deodorizer equipment known in the art, whether batch, continuous or semi-continuous deodorizer equipment. In each tray the oil is kept for a certain time at high temperature and steam is introduced into the oil.

It has been found that the height to diameter ratio of the stripping column of the oil refining equipment is from 0.1 to 10, from 0.5 to 5, from 1 to 4.9, from 1.4 to 4.7, from 1.5 to 4.4, from 1.6 to 4.0, or from 1.6 to 3.0.

The packing can be random packing or structured packing. Preferably the packing is a structured packing.

The term structured packing is well-known in the technical field and it refers to a range of specially designed materials for use in absorption and distillation columns. Structured packings typically consist of thin corrugated metal plates arranged in a way that force fluids to take complicated paths through the column and thereby creating a large surface, which can enhance the interaction between oil and stripping agent.

The packing in the equipment of the present invention is having a specific surface of from 100 to 750 m²/m³, from 100 to 500 m²/m³, from 150 to 400 m²/m³, from 150 to 300 m²/m³, from 200 to 250 m²/m³.

Furthermore, the stripping column of the oil refining equipment has an oil loading of from 0.5 to 4.0 kg/m²h surface of packing, from 0.6 to 3.5 kg/m²h surface of packing, from 0.8 to 3.3 kg/m²h, from 1.0 to 3.0 kg/m²h, from 1.5 to 2.8 kg/m²h, from 2.0 to 2.5 kg/m²h, preferably from 1.0 to 3.0 kg/m²h.

### The Use of a Short-Path Evaporation

The present invention further relates to the use of short-path evaporation for removing impurities from a vegetable oil, wherein the short-path evaporation is performed at a pressure of below 1 mbar, at an evaporator temperature in a range of from 50 to below 150° C. and with a feed rate per unit area of evaporator surface of the short-path evaporation equipment of more than 25 kg/h·m², and wherein a retentate vegetable oil and distillate is obtained.

In one aspect, the current invention relates to the use wherein the short-path evaporation of the current invention is performed at an evaporator temperature in a range of from 55 to 140° C., or from 60 to 130° C. and with a feed rate per unit area of evaporator surface of the short-path evaporation equipment of more than 35 kg/h·m², or more than 45 kg/h·m²; and up to 120 kg/h·m², up to 110 kg/h·m², up to 80 kg/h·m².

The current invention further relates to the use wherein the peroxide value of the retentate vegetable oil has been reduced by at least 50%, at least 60%, at least 70%.

### EXAMPLES

### 1. Starting Material

In Example 1, a refined, bleached and deodorized (RBD) palm oil having was subjected to a short-path evaporation treatment.

In example 2, refined and bleached (RB) linseed oil, i.e. linseed oil that was not yet subjected to any a treatment at a temperature above 180° C., was subjected to a short-path evaporation treatment.

### 2. SPE Conditions

Short-Path Evaporation (SPE) Unit KDL-5 from UIC was used for the short-path evaporation treatment. The KDL-5 unit has an evaporator surface of 0.048 m²

The following conditions were applied for Example 1 and Example 2:
Feed-temperature: 40° C.
Evaporator Temp.: 120° C.
Condenser Temp.: 60° C.
Distillate Temp.: 40° C.
Retentate Temp.: 60° C.
Wiper speed: 300 rpm
Pressure: below 10⁻³ mbar
Feed rate: 0.22 liter/h and 0.60 liter/h

Conversion of applied feed rates in KDL-5 SPE Unit (in liter/hour) to a feed rate in a KD-10 industrial SPE Unit from IUC (in kg/h), and further conversion to the feed rate per unit area of evaporator surface of the short-path evaporation equipment (in kg/h·m2) for industrial scale short-path evaporation equipment is shown in table 1.

TABLE 1
Conversion of applied feed rates

| | Corresponding | Feed rate per unit area of evaporator surface |
|---|---|---|
| Feed rate | feed rate | of in KD10 (kg/h · m²) (=Specific |
| in KDL-5 | in KD-10 | throughput (in kg/h · m2) for industrial |
| (in liter/h) | (in kg/h) | scale short-path evaporation equipment |
| 0.22 | 2.7 | 27.0 |
| 0.60 | 7.5 | 75.0 |

Thus, the example is conducted according to the specifications of the claims.

### 3. Analyses

The content of free fatty acids (FFA) of the starting material and the retentate oil was measured according to AOCS method Ca 5a-40. The FFA content of starting material and retentate oil from Example 1 was expressed as percentage of palmitic acid. The FFA content of starting material and retentate oil from Example 2 was expressed as percentage of oleic acid. Peroxide value (PV) of the retentate vegetable oil was measured according to AOCS method Cd 8b-90. PV is expressed in meq/kg.

Oxidation Stability Index (OSI) of the starting material and the retentate oil was measured at a temperature of 110° C. according to AOCS method Cd12b-92. OSI is expressed in hour.

### 4. Example 1

FFA and PV were analyzed for the oils before the SPE treatment (=starting material of test) and after (=retentate oil of test). The yield of the retentate oil was calculated based on the amount of retentate oil after SPE treatment versus the amount starting material before the SPE treatment. The results are shown in Table 2.

TABLE 2
results Example 1

| | FFA | PV | Yield |
|---|---|---|---|
| Starting material | 0.13 wt. % | 1.13 meq/kg | n.a. |
| Retentate oil obtained from SPE | | | |
| treatment at flow speed: | | | |
| 0.22 liter/h | 0.05 wt. % | 0.78 meq/kg | >99.9% |
| 0.60 liter/h | 0.08 wt. % | 0.78 meq/kg | >99.9% |

n.a.—not applicable

### 5. Example 2

FFA and OSI were analyzed for the oils before the SPE treatment (=starting material of test) and after (=retentate oil of test). The yield of the retentate oil was calculated based on the amount of retentate oil after SPE treatment versus the amount starting material before the SPE treatment. The results are shown in Table 3.

TABLE 3
results Example 2

| | | OSI ate | |
|---|---|---|---|
| | FFA | 110° C. | Yield |
| Starting material | 0.15 wt. % | 2.55 h | n.a. |
| Retentate oil obtained from SPE | | | |
| treatment at flow speed: | | | |
| 0.22 liter/h | 0.06 wt. % | 2.64 h | >99.9% |
| 0.60 liter/h | 0.08 wt. % | 2.94 h | >99.9% |

1. A process for removing impurities, wherein the process is comprising the step of subjecting a vegetable oil to a short-path evaporation, wherein the short-path evaporation is performed at a pressure of below 1 mbar, at an evaporator temperature in a range of from 50 to below 150° C. and with a feed rate per unit area of evaporator surface of the short-path evaporation equipment of more than 25 kg/h·m², and thus obtaining a retentate vegetable oil and a distillate.

2. The process according to claim 1, wherein the short-path evaporation is performed at a pressure below 0.01 mbar.

3. The process according to claim 1, wherein the short-path evaporation is performed at an evaporator temperature in a range of from 50 to below 150° C. and with a feed rate per unit area of evaporator surface of the short-path evaporation equipment of more than 25 kg/h·m² and up to 120 kg/h·m².

4. The process according to claim 1, wherein the step of subjecting a vegetable oil to a short-path evaporation is carried out multiple times.

5. The process according to claim 1, wherein the vegetable oil has been subjected to a treatment at a temperature above 180° C. prior to the step of subjecting the vegetable oil to the short-path evaporation and the vegetable oil has an FFA content in a range of more than 0.05% and/or a peroxide value of more than 0.5 meq peroxide/kg.

6. The process according to claim 1, wherein the vegetable oil has not been subjected to a treatment at a temperature above 180° C. prior to the step of subjecting the vegetable oil to the short-path evaporation.

7. The process according to claim 6, wherein the vegetable oil has an iodine value of more than 70.

8. The process according to claim 6, wherein the obtained retentate vegetable oil is subjected to a further refining carried out in an oil refining equipment consisting of a stripping column with packing and not more than one oil collection tray, or in a deodorizer at a temperature below 150° C., and a refined retentate vegetable oil is obtained.

9. The process according to claim 8, wherein the further refining is carried out in the presence of sparge steam in an amount of from 0.1 to 2.0 wt based on amount of oil.

10. The process according to claim 8, wherein the further refining is carried out at an absolute pressure of 10 mbar or less.

11-12. (canceled)
